(19) United States
(12) Patent Application Publication
(10) Pub. No.: US 2026/0162222 A1
(43) Pub. Date: Jun. 11, 2026

(54) COMPUTING DEVICE, EDGE DEVICE, AND METHOD FOR ARTIFICIAL INTELLIGENCE INFERENCE ON VIDEO STREAM

(71) Applicant: Novatek Microelectronics Corp., Hsinchu (TW)

(72) Inventors: Chun-Ning Chiu, Taichung City (TW); Chi-Ming Yuan, Taipei City (TW); Kun-Yueh Hsieh, Hsinchu City (TW); Wen-Chi Lin, Yilan County (TW); Chin-Chu Wu, Taichung City (TW); Guan-An Shih, Hsinchu County (TW); Chia-Wei Huang, Taichung City (TW); Ya-Ling Chen, Tainan City (TW)

(73) Assignee: Novatek Microelectronics Corp., Hsinchu (TW)

(21) Appl. No.: 18/973,082

(22) Filed: Dec. 8, 2024

(51) Int. Cl. G06T 5/50; G06T 3/40

(52) U.S. Cl. CPC G06T 5/50; G06T 3/40; G06T 2207/20221

(57) ABSTRACT

A computer device, an edge device, and a method for an artificial intelligence (AI) inference on a video stream are proposed. The computing device at least includes a first processor and a second processor. The first processor is configured to continuously receive a main video stream. The second processor is configured to perform scaling on the main video stream to generate a scaled video stream and to perform AI inference on a first frame of the scaled video stream to generate an AI inference result for a second frame of the main video stream, where the second frame of the main video stream is a frame corresponding to a time point when or after the AI inference result is generated.

### TECHNICAL FIELD

The disclosure relates to a technique for an artificial intelligence (AI) inference on a video stream.

### BACKGROUND

An edge device refers to equipment such as a sensor, a gateway, an actuator, an IoT device, which enables data to be gathered and processed at the edge of a network. Such edge computing infrastructure with AI inference not only brings computation closer to the source of the data and significantly diminishes the need for extensive data transfer to the cloud, but also results in saving bandwidth, enabling faster decision-making, and reducing response time. However, with recent advances in both high-quality video streaming and high frame-rate display technology, real-time AI inference at the edge poses challenges due to power and computing constraints.

### SUMMARY OF THE DISCLOSURE

To solve the prominent issues, a computer device, an edge device, and a method for an artificial intelligence (AI) inference on a video stream are proposed.

According to one of the exemplary embodiments, the computer device includes a first processor and a second processor. The first processor is configured to continuously receive a main video stream. The second processor is configured to perform scaling on the main video stream to generate a scaled video stream and to perform AI inference on a first frame of the scaled video stream to generate an AI inference result for a second frame of the main video stream, where the second frame of the main video stream is a frame corresponding to a time point when or after the AI inference result is generated.

According to one of the exemplary embodiments, the computer device includes a first processor, a second processor, and an on-screen display controller. The first processor is configured to continuously receive a main video stream. The second processor is configured to perform scaling on the main video stream to generate a scaled video stream and to perform AI inference on a first frame of the scaled video stream to generate an AI inference result. The on-screen display controller is configured to superimpose texts or graphs on a second frame of the main video stream according to the AI inference result, where the second frame of the main video stream is a frame corresponding to a time point when or after the AI inference result is generated.

According to one of the exemplary embodiments, the edge device includes a computing device and a screen monitor. The computing device includes a first processor, a second processor, and an on-screen display controller. The first processor is configured to continuously receive a main video stream. The second processor is configured to perform scaling on the main video stream to generate a scaled video stream and to perform AI inference on a first frame of the scaled video stream to generate an AI inference result. The on-screen display controller is configured to superimpose texts or graphs on a second frame of the main video stream according to the AI inference result, where the second frame of the main video stream is a frame corresponding to a time point when or after the AI inference result is generated. The screen monitor is configured to display the processed second frame.

According to one of the exemplary embodiments, the method includes to continuously receive a main video stream, perform scaling on the main video stream to generate a scaled video stream, and perform AI inference on a first frame of the scaled video stream to generate an AI inference result for a second frame of the main video stream, where the second frame of the main video stream is a frame corresponding to a time point when or after the AI inference result is generated.

According to one of the exemplary embodiments, the method includes to continuously receive a main video stream, perform scaling on the main video stream to generate a scaled video stream, perform AI inference on a first frame of the scaled video stream to generate an AI inference result, and superimpose texts or graphs on a second frame of the main video stream according to the AI inference result, where the second frame of the main video stream is a frame corresponding to a time point when or after the AI inference result is generated.

According to one of the exemplary embodiments, the method includes to continuously receive a main video stream, perform scaling on the main video stream to generate a scaled video stream, perform AI inference on a first frame of the scaled video stream to generate an AI inference result, and superimpose texts or graphs on a second frame of the main video stream according to the AI inference result, and display the processed second frame on a screen monitor, where the second frame of the main video stream is a frame corresponding to a time point when or after the AI inference result is generated.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of a computing device in accordance with an exemplary embodiment of the disclosure.

FIG. 2 illustrates a flowchart of a computing method for an AI inference on a video stream in accordance with an exemplary embodiment of the disclosure.

FIG. 3 illustrates an adaptive AI inference scheme in accordance with an exemplary embodiment of the disclosure.

FIG. 4 illustrates a schematic diagram of an edge device in accordance with an exemplary embodiment of the disclosure.

FIG. 5 illustrates a flowchart of a method for an AI inference on a video stream in accordance with an exemplary embodiment of the disclosure.

FIG. 6 illustrates a schematic diagram of how an edge device works in accordance an exemplary embodiment of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

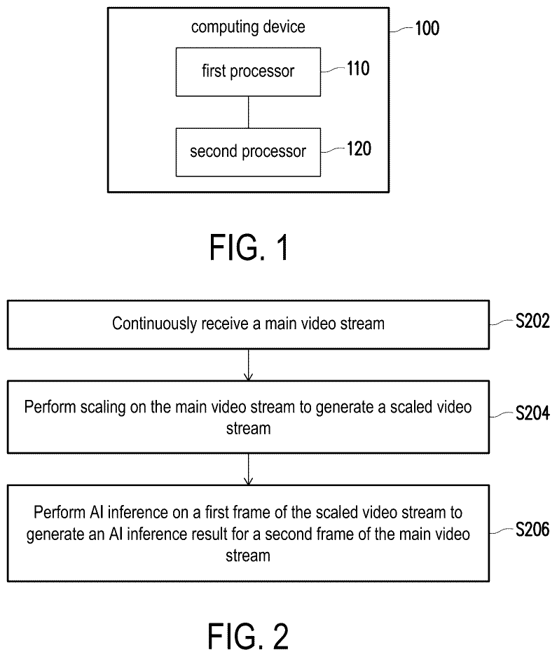

FIG. 1 illustrates a schematic diagram of a computing device in accordance with an exemplary embodiment of the disclosure. All components and configurations of the computing device are first introduced in FIG. 1. The functionalities of the components are explained in more details later on.

Referring to FIG. 1, a computing device 100 would include a first processor 110 and a second processor 120 coupled or connected thereto. The computing device 110 may be a stand-alone computer or piece of infrastructure embedded in an edge device with image processing capability. For illustrative purposes, the edge device may be an in-vehicle computer that is capable of alerting potentially dangerous road situations. Each of the first processor 110 and the second processor 120 may be a central processing unit (CPU), a graphical processing unit (GPU), an application processor (AP), a programmable general purpose or special purpose microprocessor, a digital signal processor (DSP), a field programmable array (FPGA), an application specific integrated circuit (ASIC), other similar devices, integrated circuits, or a combination thereof. The first processor 110 and the second processor 120 may also be formed as integrated circuits such as a system-on-chip (SoC), and yet the disclosure is not limited in this regard.

FIG. 2 illustrates a flowchart of a computing method for an AI inference on a video stream in accordance with an exemplary embodiment of the disclosure, where the steps of FIG. 2 may be implemented by the computer device 100 as illustrated in FIG. 1.

Referring to FIG. 2 in conjunction with FIG. 1, the first processor 110 of the computing device 100 would continuously receive a main video stream (Step S202). In the present exemplary embodiment, the main video stream may be a live video feed received from a source, such as an in-vehicle camera, a surveillance camera, or any other video source devices. In other exemplary embodiments, the main video stream may also be an offline video stream such as video gaming, video animation, or pre-stored video contents.

Next, the second processor 120 of the computing device 100 would perform scaling on the main video stream to generate a scaled video stream (Step S204). In computer graphics, image scaling also refers to image resizing which primarily includes image reduction and image magnification. Image reduction is to downscale the original image dataset based on an image reduction ratio in order to reduce the computational load as well as the algorithm execution time. Image magnification is to upscale the original image dataset based on an image magnification ratio in order to investigate fine details in local areas. In one scenario, the second processor 120 may perform image reduction on the main video stream to generate the scaled video stream. In another scenario, the second processor 120 may perform image magnification on a predetermined region of the main video stream with potential or confirmed presence of specific features to generate the scaled video stream. Yet in another scenario, the second processor 120 may perform image reduction on the aforesaid predetermined region of the main video stream for optimal processing efficiency.

The second processor 120 would perform various video analytics tasks on the scaled video stream such as objection detection, scene identification, and facial recognition for predictive decision-making based on any AI inference scheme. To process video frames seamlessly under computational constraints while realizing low-latency AI inference to maintain real-time responsiveness, the second processor 120 would perform AI inference on the scaled video stream at dynamic inference time points based on image contents. To be specific, the second processor 120 of the computing device 100 would perform AI inference on a first frame of the scaled video stream to generate an AI inference result for a second frame of the main video stream (Step S206), where the second frame of the main video stream refers to a frame corresponding to a time point when or after the AI inference result is generated. For example, the second frame of the main video stream may be a current frame of the main video stream at the time point when the interference result is generated or an immediate next frame of the main video stream after the time point when the AI inference result is generated.

It should be noted that, since the time span of each AI inference is dynamic based on complexity of image content, the next AI inference would be performed on a frame of the scaled video stream corresponding to the latest frame of the ongoing main video stream received by the first processor 110. That is, the second processor 120 would perform AI inference on the frame of the main video corresponding to a time point when or after the AI interference result is generated to generate a new AI inference result for a third frame of the main video stream, where the third frame of the main video stream refers to a frame corresponding to a time point when or after the new AI inference result is generated.

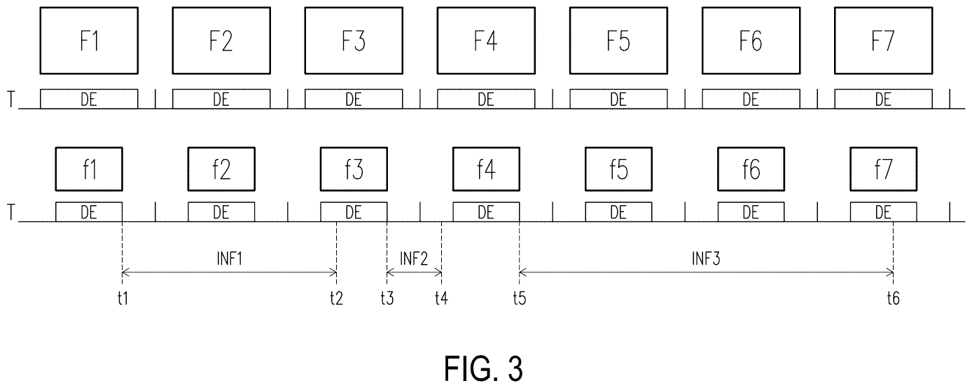

For better comprehension, FIG. 3 illustrates an adaptive AI inference scheme in accordance with an exemplary embodiment of the disclosure.

Referring to FIG. 3, a main video stream including frames F1-F7 and a scaled video stream including frames f1-f7 are plotted on two aligned time axes T. The second processor 120 would start performing AI inference INF1 on the frame f1 of the scaled video stream after the corresponding data enable (DE) signal is inactive at time t1 and generate an AI inference result at time t2. The AI inference result generated at time t2 may be applicable to the frame F3 or the frame F4 of the main video stream. Since the time span of AI inference ends at a time point at which the data enable signal corresponding to the frame f3 has already been active, the processor 120 would discard the frame f2 of the scaled video stream and start processing the frame f3 corresponding to the latest frame F3 of the main video stream. That is, the second processor 120 would start performing AI inference INF2 on the frame f3 after the corresponding data enable signal is inactive at time t3 and generate an AI inference result at time t4, and the AI inference result generated at time t4 may be applicable to the frame F4 or the frame F5 of the main video stream. With a similar fashion, the second processor 120 would start performing AI inference INF3 on the frame f4 after the corresponding data enable signal is inactive at time t5 and generate an AI inference result at time t6, and the AI inference result generated at time t6 may be applicable to the frame F7 or its following frame of the main video stream. In this case, the time spans of AI inference INF1, INF2, and INF3 are dynamic and vary depending on the complexity of image contents respectively in the frame f1, the frame f3, and the frame f4. Although AI inference does not occur for every single frame, it would hardly be noticeable for human perception.

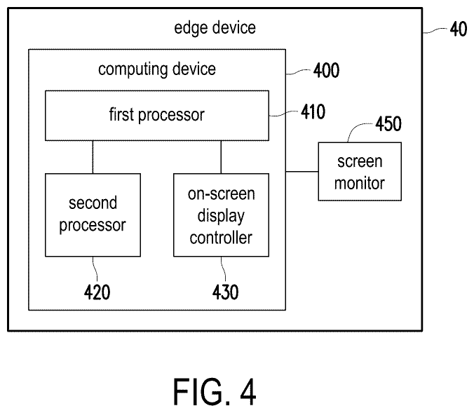

As an application scenario, FIG. 4 illustrates a schematic diagram of an edge device in accordance with an exemplary embodiment of the disclosure. All components and configurations of the computing device are first introduced in FIG. 4. The functionalities of the components are explained in more details later on.

Referring to FIG. 4, the edge device 40 would include a computing device 400 and a screen monitor 450. The edge device 40 may be an in-vehicle computer as previously illustrated, a personal computer or mobile device, an IoT device such as a smart TV, a smart surveillance camera, and so forth. The computing device 400 would further include a first processor 410, a second processor 420, and an on-screen display (OSD) controller 430, where the second processor 420 and the on-screen display controller 430 would be coupled to or connected to the first processor 410, and the on-screen display controller 430 would be coupled to or connected to the second processor 420. Note that the hardware configuration of the first processor 410 and the second processor 420 of the computing device 400 would be similar to the first processor 210 and the second processor 220 of the computing device 200 in FIG. 2. The on-screen display controller 430 may be a digital circuit that provides the functionality to create on-screen displays and may be considered a third processor of the computing device 400.

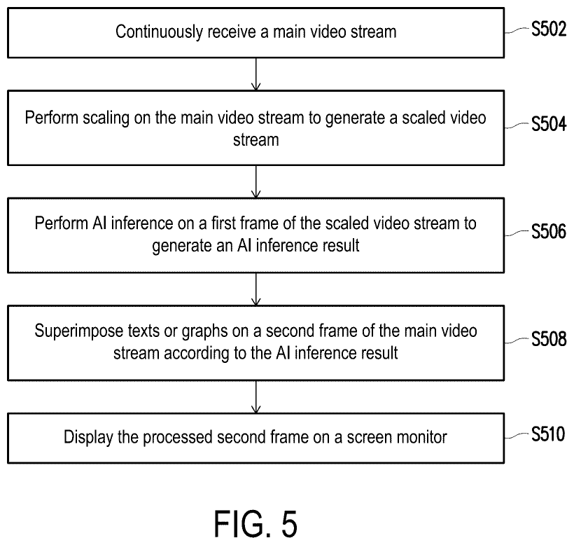

FIG. 5 illustrates a flowchart of a method for an AI inference on a video stream in accordance with an exemplary embodiment of the disclosure, where the steps of FIG. 5 may be implemented by the edge device 40 as illustrated in FIG. 4.

Referring to FIG. 5 in conjunction with FIG. 4, the first processor 410 of the computing device 400 of the edge device 40 would continuously receive a main video stream (Step S502), and the second processor 420 of the computing device 400 of the edge device 40 would perform scaling on the main video stream to generate a scaled video stream (Step S504) and perform AI inference on a first frame of the scaled video stream to generate an AI inference result (Step S506). The descriptions of Steps S502-S506 could be deduced by a skilled person in the art according to Steps S202-S206 in FIG. 2 and would be omitted for brevity.

In the present exemplary embodiment, the second processor 420 would perform image analysis on the first frame of the scaled video stream based on any image recognition technique to determine a designated object in the first frame of the scaled video stream. Such designated object may be a particular target that is subject to be detected and monitored, a particular zone or even a background scene in the first frame. The second processor 420 would generate the AI inference result with respect to the designated object in a second frame of the main video stream, where the second frame refers to a frame corresponding to a time point when or after the AI inference result is generated as previously mentioned.

The AI inference result may be outputted in a variety of representations and formats. In the present exemplary embodiment, the AI inference result would be a text or graphical form for visualization. The on-screen display controller 430 would superimpose texts or graphs on the second frame of the main video stream according to the AI inference result to generate a processed second frame (Step S508), and the screen monitor 450 would display the processed second frame (Step S510). Note that the texts or the graphs may be superimposed at a position in association with the aforesaid designated object or a predetermined region in the second frame of the main video stream.

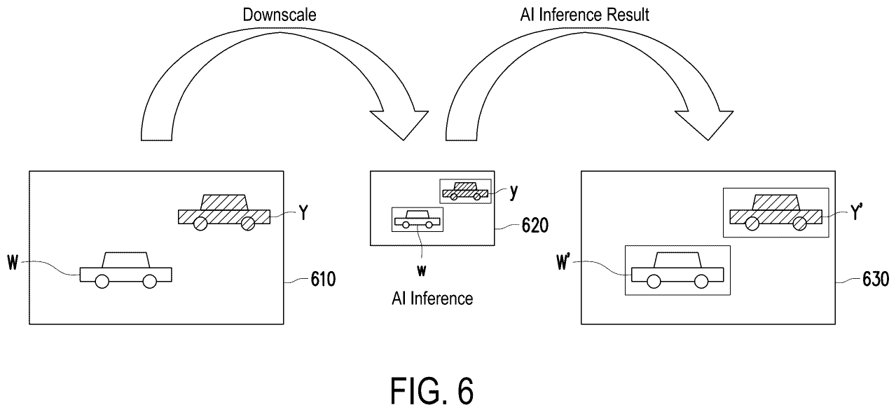

As an example, FIG. 6 illustrates a schematic diagram of how the edge device 40 works in accordance an exemplary embodiment of the disclosure. In the present exemplary embodiment, the edge device 40 may be an in-vehicle surveillance system for safety enhancement.

Referring to FIG. 6, a frame 610 in a main video stream would include a white vehicle W and a yellow vehicle Y. The frame 610 would be downscaled to a frame 620 for AI inference based on an image reduction ratio, and a white vehicle w′ and a yellow vehicle y′ in the frame 620 would be determined as an AI inference result indicating potential collision risk for the driver. Herein, the position at which the AI inference result is determined in the frame 620 may be mapped to a corresponding position in a next frame 630 in the main video stream based on the image reduction ratio. In this scenario, the AI inference result would be presented as the white vehicle with a bounding box W′ and the yellow vehicle with a bounding box Y′ in the next frame 630 in the main video stream after the AI inference result is generated to provide the alertness for the driver. The bounding boxes may be presented on one or more following frames until a new AI inference result is generated.

Revisiting FIG. 1, in one exemplary embodiment, the computing device 100 in FIG. 1 may further include an audio signal processor or digital circuit to generate a voice signal in association with a designated object in the second frame of the main video stream according to an AI inference result. For example, the voice signal may be an alert message outputted from a speaker to notify the user of the existence of the designated object.

Yet in another exemplary embodiment, the computing device 100 in FIG. 1 may further include a backlight controller or digital circuit to generate a control signal in association with a display of the second frame of the main video stream according to the AI inference result. For example, assume that an AI inference result concludes that the computing device 100 is in a dark environment, the control signal may control to provide adequate backlight for viewing the second frame of the main video stream.

In view of the aforementioned descriptions, the proposed adaptive AI inference schemes allow edge devices with limited power and computing resources to perform real-time AI inference at the edge without compromising on high-quality video streaming and high frame-rate hardware.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A computing device comprising:
a first processor, configured to continuously receive a main video stream; and
a second processor, configured to:
perform scaling on the main video stream to generate a scaled video stream; and
perform artificial intelligence (AI) inference on a first frame of the scaled video stream to generate an AI inference result for a second frame of the main video stream, wherein the second frame of the main video stream is a frame corresponding to a time point when or after the AI inference result is generated.

2. The computing device according to claim 1,
wherein the second processor performs image reduction on the main video stream to generate the scaled video stream.

3. The computing device according to claim 1,
wherein the processor performs image magnification on a predetermined region of the main video stream to generate the scaled video stream.

4. The computing device according to claim 1,
wherein the second frame of the main video stream is a current frame of the main video stream at the time point when the AI interference result is generated.

5. The computing device according to claim 1,
wherein the second frame of the main video is an immediate next frame of the main video stream after the time point when the AI interference result is generated.

6. The computing device according to claim 1,
wherein the second processor performs image analysis on the first frame of the scaled video stream to determine a designated object in the first frame of the scaled video stream, and
wherein the second processor generates the AI inference result with respect to the designated object in the second frame of the main video stream.

7. The computing device according to claim 6 further comprising:
a third processor, configured to:
generate texts or graphics according to the AI inference result and superimpose the texts or the graphics at a position in association with the designated object in the second frame of the main video stream.

8. The computing device according to claim 7, wherein the third processor determines the position at which the texts or the graphics are superimposed in the second frame of the main video stream according to the first frame of the scaled video stream and an image reduction ratio of the first frame.

9. The computing device according to claim 6 further comprising:
a fourth processor, configured to:
generate a voice signal in association with the designated object in the second frame of the main video stream according to the AI inference result.

10. The computing device according to claim 6,
a fifth processor, configured to:
generate a control signal in association with a display of the second frame of the main video stream according to the AI inference result.

11. The computing device according to claim 1, wherein the second processor is further configured to:
perform AI inference on the frame of the main video corresponding to a time point when or after the AI interference result is generated to generate a new AI inference result for a third frame of the main video stream, wherein the third frame of the main video stream is a frame corresponding to a time point when or after the new AI inference result is generated.

12. A computing device comprising:
a first processor, configured to continuously receive a main video stream;
a second processor, configured to:
perform scaling on the main video stream to generate a scaled video stream;
perform artificial intelligence (AI) inference on a first frame of the scaled video stream to generate an AI inference result; and
an on-screen display controller, configured to:
superimpose texts or graphs on a second frame of the main video stream according to the AI inference result, wherein the second frame of the main video stream is a frame corresponding to a time point when or after the AI inference result is generated.

13. The computing device according to claim 12,
wherein the second processor performs image analysis on the first frame of the scaled video stream to determine a designated object in the first frame of the scaled video stream, and
wherein the second processor generates the AI inference result with respect to the designated object in the second frame of the main video stream.

14. The computing device according to claim 12,
perform AI inference on the frame of the main video corresponding to a time point when or after the AI interference result is generated to generate a new AI inference result for a third frame of the main video stream, wherein the third frame of the main video stream is a frame corresponding to a time point when or after the new AI inference result is generated.

15. An edge device comprising:
a computing device comprising:
a first processor, configured to continuously receive a main video stream;
a second processor, configured to:
perform scaling on the main video stream to generate a scaled video stream; and
perform artificial intelligence (AI) inference on a first frame of the scaled video stream to generate an AI inference result;
an on-screen display controller, configured to:
superimpose texts or graphs on a second frame of the main video stream according to the AI inference result to generate a processed second frame, wherein the second frame of the main video stream is a frame corresponding to a time point when or after the AI inference result is generated; and
a screen monitor, configured to:
display the processed second frame.

16. The edge device according to claim 15,
wherein the second processor performs image analysis on the first frame of the scaled video stream to determine a designated object in the first frame of the scaled video stream, and
wherein the second processor generates the AI inference result with respect to the designated object in the second frame of the main video stream.

17. The edge device according to claim 15,
perform AI inference on the frame of the main video corresponding to a time point when or after the AI interference result is generated to generate a new AI inference result for a third frame of the main video stream, wherein the third frame of the main video stream is a frame corresponding to a time point when or after the new AI inference result is generated.

18. A computing method comprising:
continuously receive a main video stream;
performing scaling on the main video stream to generate a scaled video stream; and
performing artificial intelligence (AI) inference on a first frame of the scaled video stream to generate an AI inference result for a second frame of the main video stream, wherein the second frame of the main video stream is a frame corresponding to a time point when or after the AI inference result is generated.

19. A computing method comprising:
continuously receive a main video stream;
performing scaling on the main video stream to generate a scaled video stream;
performing artificial intelligence (AI) inference on a first frame of the scaled video stream to generate an AI inference result; and
superimposing texts or graphs on a second frame of the main video stream according to the AI inference result, wherein the second frame of the main video stream is a frame corresponding to a time point when or after the AI inference result is generated.

20. A method, applicable to an edge device, comprising:
continuously receive a main video stream;
performing scaling on the main video stream to generate a scaled video stream;
performing artificial intelligence (AI) inference on a first frame of the scaled video stream to generate an AI inference result;
superimposing texts or graphs on a second frame of the main video stream according to the AI inference result to generate a processed second frame, wherein the second frame of the main video stream is a frame corresponding to a time point when or after the AI inference result is generated; and
displaying the processed second frame on a screen monitor.
